(19) United States
(12) Patent Application Publication
(10) Pub. No.: US 2005/0187019 A1
(43) Pub. Date: Aug. 25, 2005

(54) Gaming machine with an electromechanical coin sound simulator

(76) Inventors: James M. Rasmussen, Chicago, IL (US); Wayne H. Rothschild, Northbrook, IL (US)

Correspondence Address: JENKENS & GILCHRIST, P.C., 225 WEST WASHINGTON, SUITE 2600, CHICAGO, IL, 60606, US

(21) Appl. No.: 11/062,052

(22) Filed: Feb. 18, 2005

Related U.S. Application Data
(60) Provisional application No. 60/546,238, filed on Feb. 20, 2004.
(60) Provisional application No. 60/568,769, filed on May 6, 2004.

(51) Int. Cl. A63F 13/00

(52) U.S. Cl. 463/35

(57) ABSTRACT

An electromechanical coin sound simulator in a gaming machine having a controller, is disclosed. The generated coin sound may be used as a sound effect during game play or may be used to audibly signify a coin award associated with a winning game outcome. The electromechanical coin sound simulator includes a motor coupled to the controller, and an arm assembly activated for rotative movement by the motor. The arm assembly includes portions adapted to strike an interior area of the gaming machine to generate the coin sound. The arm assembly may be a multilink arm assembly, a single link arm assembly, or a spring loaded arm assembly. The electromechanical coin sound simulator may also be configured with a solenoid assembly, belt-feeding coin conveyor assembly, or a disc-feeding coin conveyor assembly, to name a few.

### PRIORITY

This application claims the benefit of priority under 35 U.S.C. § 119 of provisional application Ser. Nos. (a) 60/546,238, filed Feb. 20, 2004; and (b) 60/568,769, filed May 6, 2004, the contents of which are hereby incorporated by reference in their entirety as if fully set forth.

### FIELD OF THE DISCLOSURE

This invention is directed to gaming machines, and more particularly, to a gaming machine with an electromechanical coin sound simulator.

### BACKGROUND

Gaming machines providing base games of chance such as electronically driven video slots, video poker, video blackjack, video keno, video bingo, video pachinko, video lottery, and mechanically driven reel slots, etc., are well known in the gaming industry. Generally gaming machines are configured to operate as “stand-alone” units (that may or may not be coupled to a backroom computer) where the outcome of game play is “locally determined”, or as part of a server-based gaming network where the outcome of game play may be either locally determined or “centrally determined”.

Traditionally, gaming machine play is associated with coin or token payouts. The player inserts one or more bills, or coins or tokens (referred to generically as coins) into a suitable value input device of the gaming machine and then takes some action, such as pulling a handle or pushing a button. In response, the gaming machine generates a “random” output that is displayed on a display device of the gaming machine. If the output yields a win, a value payout in the form of coins or tokens is awarded to the player. Accordingly, the player associates the excitement of a win with the sound of coins dropping into a coin tray of the gaming machine.

Despite their popularity with some players, traditional coin usage in gaming machines has several undesirable features. For example, coins sometimes jam leading to downtime of the gaming machine and frustration for the player. Having coin capability in gaming machines is also labor intensive from both a maintenance standpoint and a security standpoint. Further, having coin capability in gaming machines is expensive because of “float” requirements (i.e., ensuring that a minimum number of coins are available for value payouts).

As a result of the undesirable features associated with coins, some casinos and other gaming establishments have adopted coinless gaming machines. That is, a player inserts paper money, a voucher (e.g., ticket in/ticket out), a smart card or any suitable non-coin value (e.g., electronic funds transfer system) into the value input device of the gaming machine and then takes some action. A credit meter or equivalent device on the game machine increments a number reflecting available credits each time a value payout is awarded to the player; that is, coins do not physically drop into a coin tray of the gaming machine when a value payout is awarded. Upon completion of game play, remaining credits are dispensed to the player via a paper voucher or via a smart card, etc., or via an electronic player account.

Unfortunately, utilizing coinless gaming machines results in a more subdued environment at casinos and other gaming establishments. The coin sounds typically associated with winning are absent. The vibration of the gaming machine resulting from dropping coins is absent. In other words, from a player's perspective, some of the tactile and sound excitement associated with winning is absent with coinless gaming machines.

Unfortunately, although some gaming machine manufacturers have utilized gaming machine speakers to transmit computer generated simulated sounds of coins dropping into the coin tray, the audio and tactile experience to the player is compromised. This has resulted in some player dissatisfaction with “coinless casinos”.

### SUMMARY OF THE INVENTION

In general, the present invention is an electromechanical coin sound simulator in a gaming machine having a controller. The coin sound may be used as a sound effect during game play or may be used to audibly signify a coin award associated with a winning game outcome. The electromechanical coin sound simulator includes a motor assembly coupled to a controller of the gaming machine, and an arm assembly activated for rotative movement by the motor assembly, the arm assembly including portions adapted to strike a metallic interior portion of the gaming machine to generate an audible sound. The arm assembly may be a multilink arm assembly with radially extending arms, each having an aperture with a pivot pin through the aperture and an eccentrically mounted striking element mounted to the pivot pin for free rotation about the pivot pin. Although preferably a metallic coin, it is contemplated that the striking element may be one of any suitable shape and made from one of any suitable material for striking a surface to generate a coin sound. The arm assembly may also be configured as a single link arm assembly, a spring loaded arm assembly, to name a few. The electromechanical coin sound simulator may also be configured as a solenoid assembly, an endless belt coin conveyor assembly, a disc coin conveyor assembly, coin bucket conveyor assembly, to name a few. A sensing assembly, coupled to the controller and adapted to sense the number of striking element strikes (“strikes”), may also be included in the electromechanical coin sound simulator.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of an embodiment of a gaming machine with an electromechanical coin sound simulator in accordance with the invention.

FIG. 2 is a schematic view of an exemplary electromechanical coin sound simulator utilizing a multi-link arm assembly for coin sound simulation in the gaming machine of FIG. 1.

FIG. 3 is a more detailed view of the exemplary electromechanical coin sound simulator of FIG. 2.

FIG. 4 is an auxiliary plan view of the coin support arm assembly of the exemplary electromechanical coin sound simulator of FIGS. 2 and 3.

FIG. 5 is another auxiliary plan view of the coin support arm assembly of the exemplary electromechanical coin sound simulator of FIGS. 2 and 3.

FIG. 6 is a schematic view of an electromechanical coin sound simulator utilizing a single link arm assembly for coin sound simulation in the gaming machine of FIG. 1.

FIG. 7 is a perspective view of an electromechanical coin sound simulator utilizing a cam/motor assembly for coin sound simulation in the gaming machine of FIG. 1.

FIG. 8 is a perspective view of an electromechanical coin sound simulator utilizing a solenoid assembly for coin sound simulation in the gaming machine of FIG. 1.

FIG. 9 is a side elevation view of an electromechanical coin sound simulator utilizing an endless belt conveyor assembly for coin sound simulation in the gaming machine of FIG. 1.

FIG. 10 is a top view of the exemplary electromechanical coin sound simulator of FIG. 9.

FIG. 11 is a top and side perspective view of an electromechanical coin sound simulator utilizing a disk conveyor assembly for coin sound simulation in the gaming machine of FIG. 1.

FIG. 12 is a top view of the exemplary electromechanical coin sound simulation of FIG. 11.

FIG. 13 is a side view of the exemplary electromechanical coin sound simulation of FIG. 11.

FIG. 14 is a block diagram of a number of components of the gaming machine of FIG. 1.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF THE PREFERRED EXAMPLES

The description of the preferred examples is to be construed as exemplary only and does not describe every possible embodiment of the invention. Numerous alternative embodiments could be implemented, using either current technology or technology developed after the filing date of this patent, which would still fall within the scope of the claims defining the invention.

In general, the present invention provides a gaming machine with an electromechanical coin sound simulator. As described below, the present invention is preferably implemented using a video gaming machine. It is contemplated that the present invention may also be implemented using an electromechanical spinning reel gaming machine.

An advantageous feature of the gaming machine with an electromechanical coin sound simulator as described herein is that, unlike other coinless gaming machines having computer generated or computer simulated coin sounds, the gaming machine with an electromechanical coin sound simulator delivers a realistic audio and tactile player experience associated with coins dropping into a coin tray upon a winning game outcome. In addition to generating the sound of coins dropping into a coin tray upon a winning game outcome, the electromechanical coin sound simulator may also be utilized in conjunction with a game theme and may therefore be used at other times during game play.

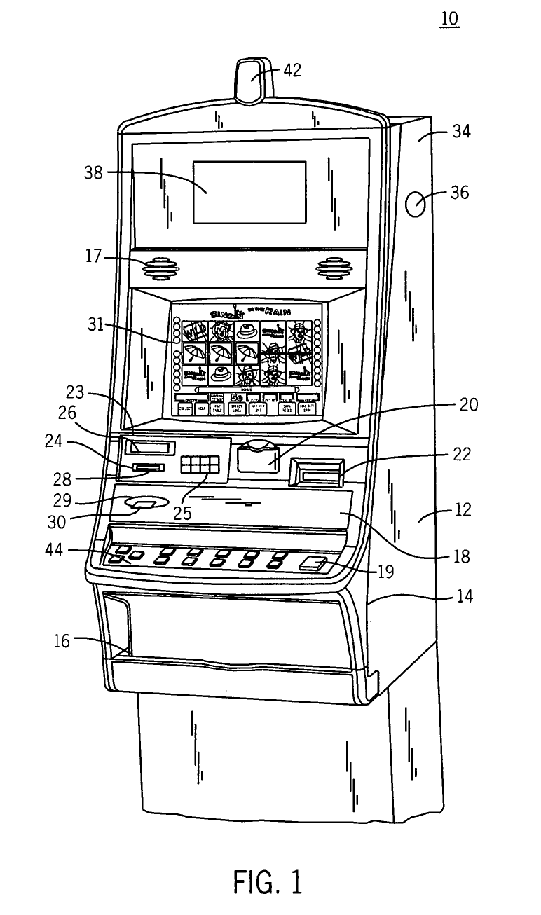

FIG. 1 is a perspective view of an embodiment of a coinless gaming machine 10 having an electromechanically generated coin sound simulator. The gaming machine 10 may be configured as a stand-alone gaming machine or may be configured as part of a server-based gaming network having one or more coupled servers and a number of additional gaming machines. The gaming machine 10 may be any type of wagering gaming machine with an electromechanically generated coin sound simulator and may therefore have varying structures and methods of operation. For example, the gaming machine 10 may be a video gaming machine configured to play a video wagering game, or it may be a mechanical spinning reel slot machine (with or without an arm mechanism). For exemplary purposes, various elements of the gaming machine 10 are described below, but it should be understood that numerous other elements may exist and may be utilized in any number of combinations to create a variety of gaming machine types.

Referring to FIG. 1, the gaming machine 10 includes a cabinet 12 having a door 14 to provide access to the interior of the gaming machine 10. A metallic coin tray 16 positioned proximate to the bottom portion of the door 14 is also included. As is known, gaming machine coin trays such as the coin tray 16 provide a player accessible receptacle for dispensed coins resulting from a winning outcome during game play or for dispensed coins remaining at the end of game play. In the case of the gaming machine 10 however, a concealed interior portion of the coin tray 16 or any suitable portion of the gaming machine 10, either interior or exterior, may provide a surface on which to generate an electromechanical coin sound simulation or, on which to mount an electromechanical coin sound simulator for coin sound simulation.

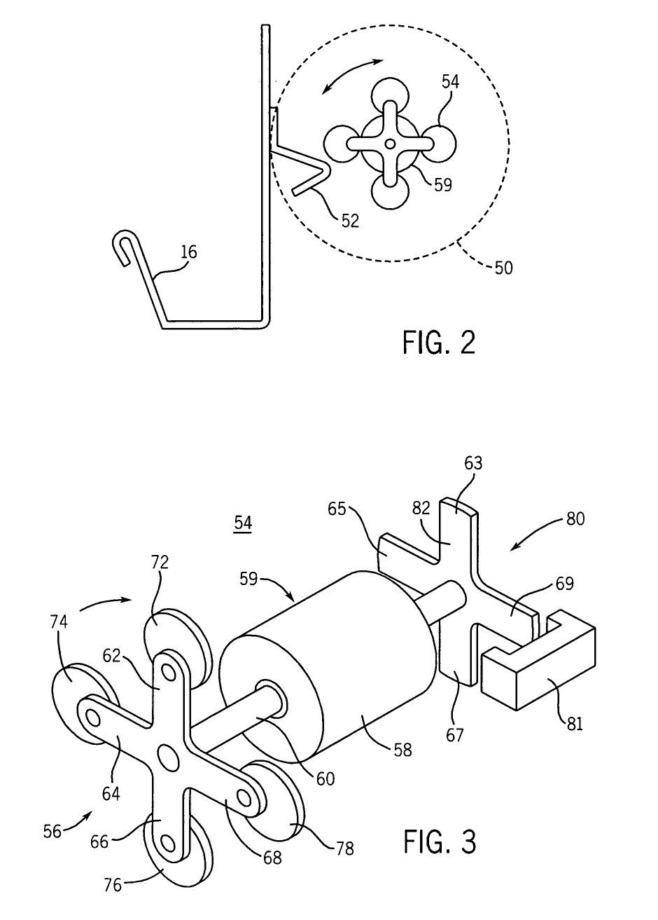

For example, FIG. 2 illustrates a perspective view of one embodiment of an electromechanical coin sound simulator 50 for coin sound simulation according to an embodiment of the invention. The electromechanical coin sound simulator 50 includes a multilink arm assembly 54 having portions adapted to strike a metallic, first interior portion of the gaming machine 10 in response to operation of a motor assembly 59. In the illustrated example of FIG. 2, the metallic, first interior portion is configured as a metallic striker panel 52 mounted to a second interior portion (e.g., an interior portion of the coin tray 16) of the gaming machine 10. Accordingly, the multilink arm assembly 54, in response to the motor assembly 59, is adapted to strike the metallic striker panel 52 to generate audible sounds substantially identical to the sounds generated by game coins dropping into the coin tray 16. Although shown mounted to the coin tray 16, it is contemplated that the striker panel 52 may be mounted to any suitable interior portion or exterior portion of the gaming machine 10.

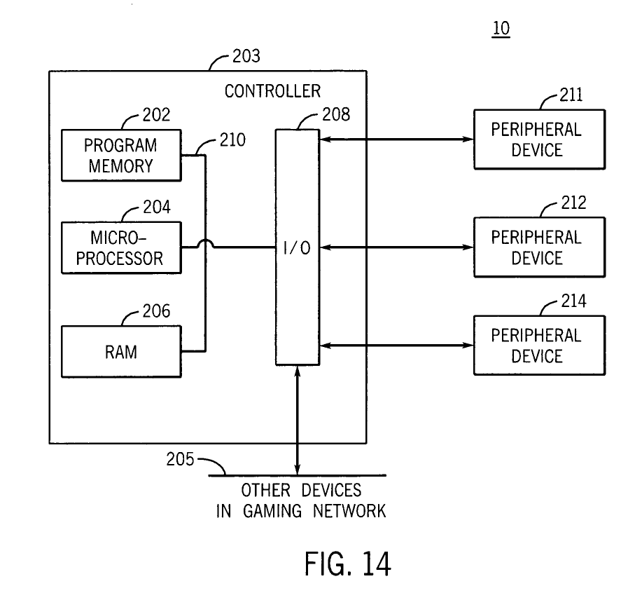

FIG. 3 shows a more detailed perspective view of the multilink arm assembly 54 of FIG. 2. The multilink arm assembly 54 includes a coin support arm assembly 56 having radially extending arms 62, 64, 66, and 68, and the motor assembly 59 having a motor 58 (e.g., a variable speed motor) and a motor drive shaft 60. The coin support arm assembly 56 is coupled to the motor 58 via the motor drive shaft 60. In addition to a power source (not separately illustrated), the motor assembly 59 is communicatively coupled to a controller 203 (discussed in connection with FIG. 14) of the gaming machine 10.

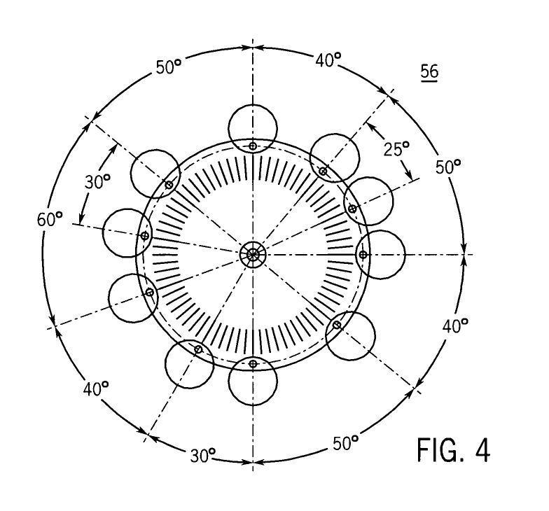

Each of the arms 62, 64, 66, and 68 has an aperture, proximate to the end of each arm, with a pivot pin therethrough. Although shown as equidistant from each other, it is contemplated that the arms 62, 64, 66, 68 may vary in distance (varied pitch) from each other (see, FIG. 4). In addition, although the arms 62, 64, 66, 68 are shown to be of substantially equal length, it is contemplated that they may vary in length. Similarly, although illustrated as having four arms, the coin support arm assembly 56 may include more or less arms.

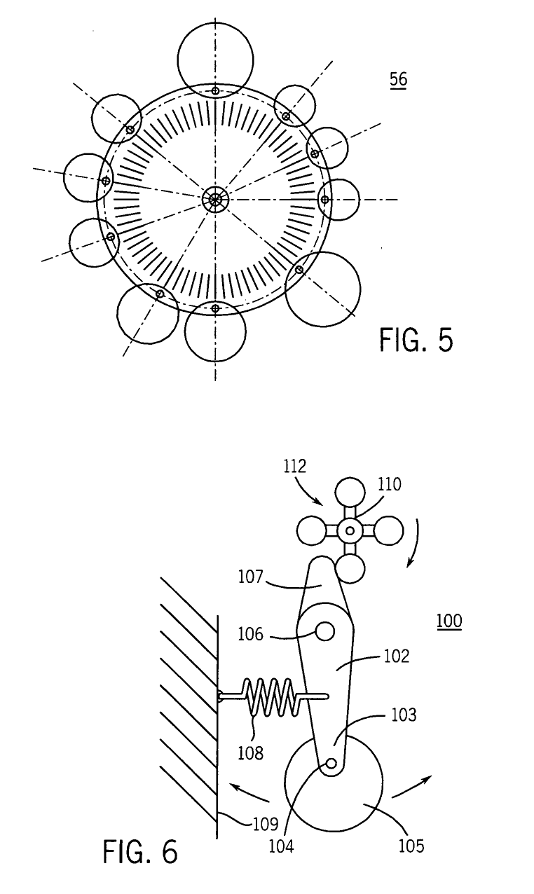

Striking elements 72, 74, 76, and 78 are eccentrically mounted to respective arms 62, 64, 66, 68 for free rotation about their respective pivot pin. Although preferably metallic coins, it is contemplated that the elements 72, 74, 76, 78 may be one of any suitable shapes and made from one of any suitable materials configured to generate a coin sound when striking a surface. Although FIG. 3 illustrates one freely rotating coin per arm 62, 64, 66, 68, it is contemplated that groups of two or more coins may be mounted to each arm. Further, it is contemplated that the striking elements may vary in size and may be mounted to their respective pivot pins at various striking element locations (see FIG. 5). In addition, although preferably loosely riveted, the striking elements 72, 74, 76, 78 may be coupled to the to the multilink arm 56 via one of any number of means that allows the striking elements 72, 74, 76, 78 to spin freely about an eccentric axis point of the coins. It is also contemplated that the respective arms 62, 64, 66, 68 may not include the striking elements 72, 74, 76, 78 and may instead be the striking elements.

During operation, as the motor drive shaft 60 rotates due to centrifugal force, the striking elements 72, 74, 76, 78 extend to their outermost position. Upon striking the striker panel 52, the striking elements 72, 74, 76, 78 are pivoted into many positions and can therefore maintain contact with the striker panel 52 for a brief time or a longer time and/or can rotate out of the way of the striker panel 52. Accordingly, audible sounds and tactile vibrations are generated that are substantially identical to the coin sounds and gaming machine vibrations generated when metallic game coins are dropped into the coin tray 16. Further, the audible sounds and tactile vibrations generated by the striking elements 72, 74, 76, 78 striking the striker panel 52 are robust and can be varied by varying the speed of the motor 58, varying the type of the motor 58, varying the size and/or type of striking element, varying the distance of the coin support arm assembly 56 from the striker panel 52, varying the number and size of the coins, and varying the rivet locations on the striking elements 72, 74, 76, 78, to name a few.

The multilink arm assembly 54 may also include a sensing assembly 80 configured to detect the number of striking elements 72, 74, 76, 78 striking the striker panel 52. Strikes may be counted for one of any number of purposes such as for accounting purposes. In the illustrated example, the sensing assembly 80 is mounted to a separate location on the motor drive shaft 60 and is communicatively coupled to the controller 203 or to another controller, for example, to a coupled server controller.

The sensing assembly 80 includes a multilink arm paddle 82 and sensor 81. The sensor 81 is preferably an optical sensor. The multilink arm paddle 82 includes radially extending paddles 63, 65, 67, and 69 that are in fixed alignment with the arms 62, 64, 66, 68 of the first multilink arm 54 and rotate with the motor drive shaft 60. As the paddles 63, 65, 67, 69 are rotated near the sensor 81, a light path generated by the sensor 81 is correspondingly interrupted each time one of the striking elements 72, 74, 76, 78 impacts against the striker panel 52. Each light interruption corresponds to each strike and therefore the total number of strikes may be detected and counted.

Although illustrated as an optical sensing assembly 80, it is contemplated that strikes may be counted via other counter assemblies such as a stepper motor assembly, a traditional encoder assembly, a Hall Effect sensor assembly or any other suitable counter assembly.

A single link arm assembly may also be used as an electromechanical coin sound simulator in the gaming machine 10. For example, FIG. 6 illustrating one embodiment of this type of coin sound simulator, depicts a front view of an electromechanical coin sound simulator utilizing a single link arm assembly 100 for coin sound simulation in the gaming machine 10.

The single link arm assembly 100 includes a spring loaded link arm 102 and a motor assembly 110 having a motor (e.g., a variable speed motor), and a motor drive shaft configured as discussed in connection with FIG. 3. In addition to a power source (not separately illustrated), the motor assembly 110 is communicatively coupled to the controller 203. In response to operation of the motor assembly 110, portions of spring loaded link arm 102 are adapted to preferably strike a first interior portion 109 of the gaming machine 10 to generate audible sounds and tactile vibrations that are substantially identical to the coin sounds and gaming machine vibrations generated when metallic game coins are dropped into the coin tray 16. It is contemplated that the single link arm assembly 100 may also be adapted to strike a suitable exterior portion of the gaming machine 10.

The spring loaded link arm 102 includes an elongated arm piece having a first aperture at a first end 103 with a first pivot pin 104 through the first aperture, and second aperture. A striking element 105 is eccentrically or centrically mounted to the first pivot pin 104 for free rotation about the first pivot pin 104. Although preferably a metallic coin, it is contemplated that the striking element 105 may be one of any suitable shapes and made from one of any suitable materials for striking a surface of the gaming machine 10 to generate a coin sound.

The second aperture, having a second pivot pin 106 therethrough, is located between a second end 107 and a middle portion of the spring loaded link arm 102 such that the spring loaded arm 102 extends above the second aperture. The second pivot pin 106 is fixed mounted to a second interior portion of the gaming machine 10, and therefore enables the spring loaded link arm 102 to rotatively move about the second pivot pin 106.

A resilient member, or spring 108, is coupled between a lower portion of the spring loaded link arm 102 (proximate to the striking element 105) and the first interior portion 109 of the gaming machine 10. The spring 108 is configured to bias the lower portion of the spring loaded link arm 102 towards the metallic surface of the first interior portion 109.

The motor assembly 110 also includes an actuating pin assembly 112 coupled to the motor drive shaft (not separately illustrated). The actuating pin assembly 112 is positioned proximate to, and in the same plane as, the second end 107 of the spring loaded link arm 102, and is configured with a plurality of radially extending pins adapted to engage and then release the second end 107.

During operation, as the motor drive shaft of the motor assembly 110 rotates causing one of the radially extending pins to engage the second end 107, the second end 107 is rotatively moved about the second pivot pin 106 toward the first interior portion 109, thereby urging the first end 103 away from the first interior portion 109, and extending the spring 108. As the radially extending pin continues movement through its rotation and subsequently disengages from the second end 107 of the spring loaded link arm 102, the force generated by the extended spring 108 rapidly pulls the first end 103 towards the first interior portion 109, causing the striking element 105 to strike the first interior portion 109, thereby generating the sound of one coin striking the coin tray 16. Accordingly, as the multiple pins of the actuating pin assembly 112 engage and disengage the second end 107 of the spring loaded link arm 102, audible sounds and vibrations associated with multiple coins striking the coin tray 16 are generated. A sensing assembly adapted to count the number of strikes as described above, may also be included in the single link arm assembly 100.

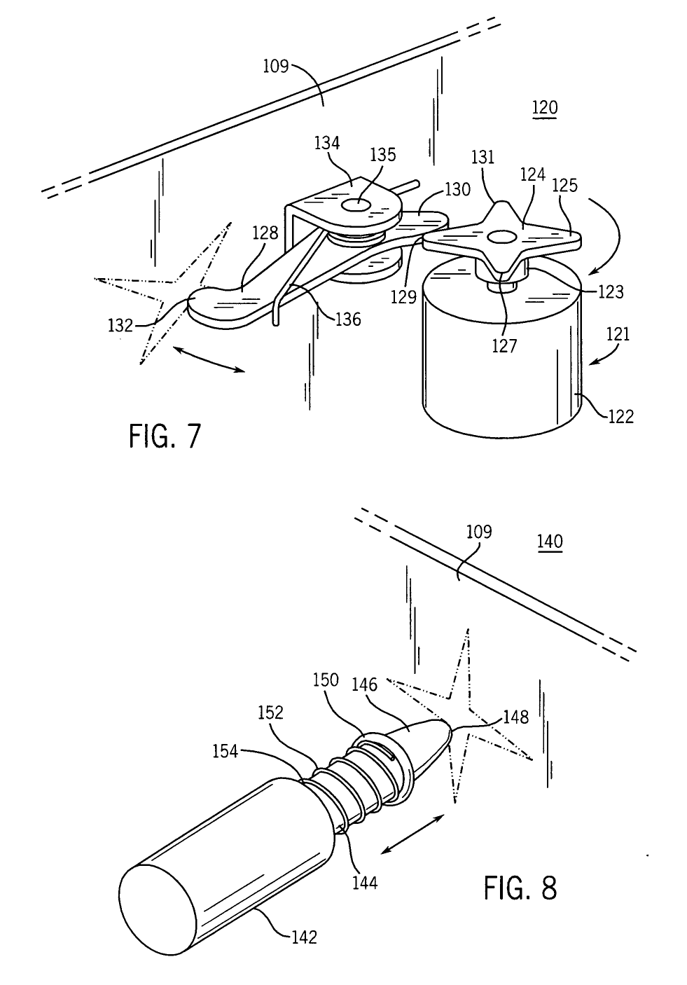

A cam/motor assembly with a spring biased arm may also be used as an electromechanical coin sound simulator in the gaming machine 10. For example, FIG. 7 illustrating one embodiment of this type of coin sound simulator, depicts a perspective view of an electromechanical coin sound simulation apparatus utilizing a cam/motor assembly 120 in conjunction with a first interior portion 109 of the gaming machine 10 (e.g., an interior portion of the coin tray 16) for coin sound simulation in the gaming machine 10. It is contemplated that the cam/motor assembly 120 may also be utilized in conjunction with a suitable exterior portion of the gaming machine 10.

Referring to FIG. 7, the cam/motor assembly 120 includes a motor assembly 121 and a spring biased arm 128 activated for rotative movement by the motor assembly 121. In addition to a power source (not separately illustrated), the motor assembly 121 is communicatively coupled to the controller 203, and includes a motor 122 and a cam 124 coupled to the motor 122 via a motor drive shaft 123. The cam 124, rotatably driven by the motor 122 via the motor drive shaft 123, is configured to cause the spring biased arm 128 to repeatedly impact the first interior portion 109 to generate audible sounds and tactile vibrations that are substantially identical to the coin sounds and gaming machine vibrations generated when metallic game coins are dropped into the coin tray 16.

The cam 124 includes four elongated extensions 125, 127, 129, and 131 with dwell portions therebetween. The spring biased arm 128 includes a cam follower portion 130 and an extension portion 132 opposite the cam follower portion 130. In the illustrated example, the spring biased arm 128 is coupled to the first interior portion 109 via a bracket 134. The bracket 134 includes two flanges with each flange having an aligned aperture with a pivot pin 135 therethrough. A spring 136 disposed around the pivot pin 135 is adapted to bias the extension portion 132 of the spring biased arm 128 in a clockwise direction towards impact with the first interior portion 109.

As the motor driving shaft 123 is rotated by the motor 122, the extensions 125, 127, 129, 131 respectively engage the cam follower portion 130 of the arm 128. While rotating, the edge surface of the cam 124 (defining the four elongated extensions with dwell portions therebetween) preferably remains in continuous contact with the cam follower portion 130. As a result, the extension portion 132 impacts the first interior portion 109 (in a clockwise direction) as the cam follower portion 130, under the influence of the spring 136 and pivoting around the pivot pin 135, drops rapidly into a respective dwell portion of the cam 124. The extension portion 132 is then drawn away from first interior portion 109 (in a counter-clockwise direction) as the cam follower portion 130, against the influence of the spring 136, is urged toward the first interior portion 109 by a respective extension of the cam 124. As will be appreciated by those skilled in the art, the depth and angle of the dwell portions as well as the speed of cam rotation are determinative of the frequency at which the extension portion 132 strikes the first interior portion 109. In addition, although described as having one cam 124 rotating responsive to operation of the motor 122, and one spring biased arm 128 pivoting responsive to rotation of the cam 124, it is contemplated that cam/motor assembly 120 may include more or less cams, gears, spring loaded arms or motors configured in one of any number of ways to generate audible sounds and vibrations associated with multiple coins striking the coin tray 16. A sensing assembly adapted to count the number of arm 128 strikes as described above, may also be included in the cam/motor assembly 120.

A solenoid assembly many also be used as an electromechanically generated coin sound simulator in the gaming machine 10. For example, FIG. 8 illustrating one embodiment of this type of sound simulator, depicts a perspective view of an electromechanical coin sound simulator utilizing a solenoid assembly 140 in conjunction with a first interior portion 109 of the gaming machine 10 for coin sound simulation in the gaming machine 10. It is contemplated that the solenoid assembly 140 may also be utilized in conjunction with a suitable exterior portion of the gaming machine 10.

Referring to FIG. 8, the solenoid assembly 140 includes a solenoid housing 142 coupled to the controller 203 and an electrical signal source (not separately illustrated). The solenoid housing is mounted to a suitable second portion of the gaming machine and is configured with a core passageway extending coaxially between a closed end and an open end 154 of the solenoid housing 142. The solenoid assembly 140 also includes a spring loaded core 144 disposed in the core passageway of the solenoid housing 142. The spring loaded core 144 is adapted to move axially in response to an electrical signal applied to the solenoid assembly 140. In addition, the spring loaded core 144 includes an extended portion extending from the open end of the solenoid housing 142.

A core striker 146 is mounted to the end of the extended portion of the spring loaded core 144 and is configured to generate an audible sound when striking the first metallic interior portion 109 of the gaming machine 10. The core striker 146 includes a striker portion 148 and a radially disposed collar 150 opposite the striker portion 148. The striker portion 148 is preferably a metallic material that is adapted to substantially reproduce the sound of a coin dropping into the coin tray 16 when the core striker 146 strikes the metallic interior portion 109. A resilient member, preferably a spring 152, extends around the extended portion of the spring loaded core 144 between the open end 154 and the collar portion 150, and biases spring loaded core 144 into contact with the first metallic interior portion 109.

Operation of the solenoid assembly 144 is controlled via a coupled controller such as the controller 203 in conjunction with the electrical signal source. During operation, the spring loaded core 144 is axially reciprocally driven as the solenoid assembly 140 is energized (electrical signal applied) and de-energized (electrical signal removed). In the illustrated embodiment, when the solenoid assembly 140 is energized, the core 144 is retracted into the solenoid housing 142, against the influence of the spring 152 and away from the metallic interior portion 109. Accordingly, when the solenoid assembly 140 is not energized, the core 144 is thrust out of the solenoid housing 142 under the influence of the spring 152 and into contact the metallic interior portion 109. Thus, each energizing/de-energizing cycle of the solenoid assembly 140 simulates the sound of one coin dropping into the coin tray 16. The sound of multiple numbers of coins may therefore be simulated by multiple energizing/de-energizing cycles of the solenoid assembly 140. In this way, audible sounds and vibrations associated with multiple coins striking the coin tray 16 may be generated by the solenoid assembly 140.

It is contemplated that the solenoid assembly 140 may also be configured with the spring 152 biasing the spring loaded core 144 away from contact with the metallic interior portion 109, and that retracts away from the first metallic interior portion 109 when the solenoid assembly 140 is not energized, and propels forward into the metallic interior portion 109 when the solenoid assembly 140 is energized. Multiple solenoid assemblies may also be utilized for coin sound simulation in the gaming machine 10. Further, in addition to utilizing the single-acting linear solenoid described above, the solenoid assembly 140 may also be configured with other solenoid types, for example, a dual acting solenoid or a rotational solenoid. The controller 203 may vary the duration and/or power delivered to the solenoid assembly 140 to simulate the “natural” random sound of coins dropping into the coin tray 16.

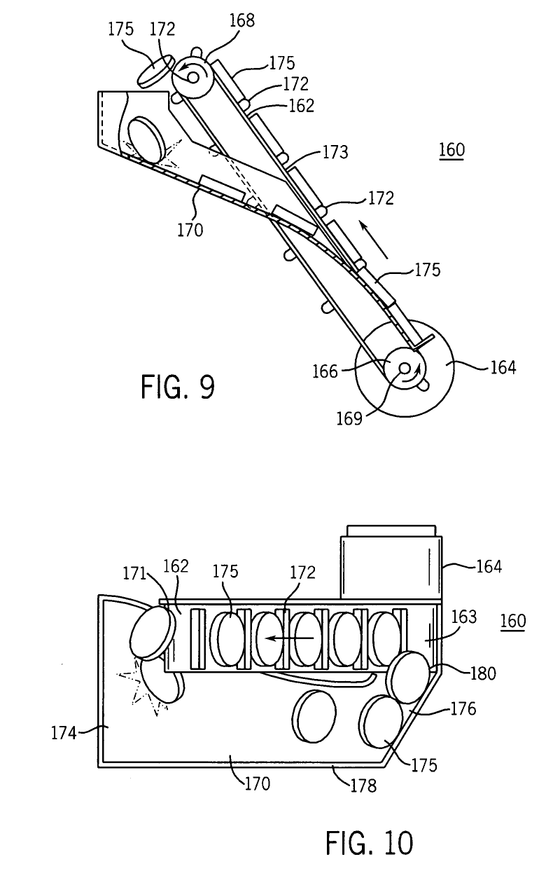

An electromechanical coin recirculator may also be used as an electromechanical coin sound simulator in the gaming machine 10. For example, FIG. 9 illustrates a side view elevation of an embodiment of an electromechanical coin sound simulator in the gaming machine 10 utilizing a coin-feeding belt conveyor assembly 160. The coin-feeding belt conveyor assembly 160 includes an endless conveyor belt 162, a motor 164, a drive roller 166, an idler roller 168 and a sound generating return plate 170. The coin-feeding belt conveyor assembly 160 is mounted to a rigid frame structure (not separately illustrated), preferably an “L-shaped” frame or a “U-shaped” frame structure, adapted to be mounted in a suitable interior area of the gaming machine 10. A blind-mate receptacle (not separately illustrated) disposed on the rigid frame structure electrically couples the coin-feeding belt conveyor assembly 160 to the controller 203.

As shown in FIG. 9, the drive roller 166 and the idler roller 168 are offset from a vertical plane, with the idler roller 168 at a higher horizontal plane and the drive roller 166 at a lower horizontal plane. The drive roller 166 is coupled to the motor 164 via a motor drive shaft 169, and rotates in a counter-clockwise direction, as viewed in FIG. 9, responsive to the motor 164. An aperture axially disposed in the center of the idler roller 168 is sized to receive a pivot pin 172, affixed to a vertical portion of the rigid frame structure (discussed above), about which, the idler roller 168 rotates. Although positioned at the lower horizontal plane, it is contemplated that the drive roller 166 and motor 164 may also be positioned at the higher horizontal plane with the idler roller at the lower horizontal plane.

The conveyor belt 162 extends around and between the drive roller 166 and the idler roller 168, and the idler roller 168 rotates responsive to rotation of the drive roller 166 via movement of the conveyor belt 162. The conveyor belt 162 includes a plurality of horizontally disposed ribs or ridges 172 on a surface 173 of the conveyor belt 162, where each of the plurality of horizontally disposed ridges 172 is adapted to hold one striking element 175 against the surface 173 through the force of gravity. The spacing between, and the number of, the plurality of ridges 172 is partially determined by the diameter of the striking element 175 in the coin-feeding belt conveyor assembly 160. Although preferably metallic coins, it is contemplated that the striking element 175 may be one of any suitable shape and made from one of any suitable material configured to generate a coin sound when striking a surface.

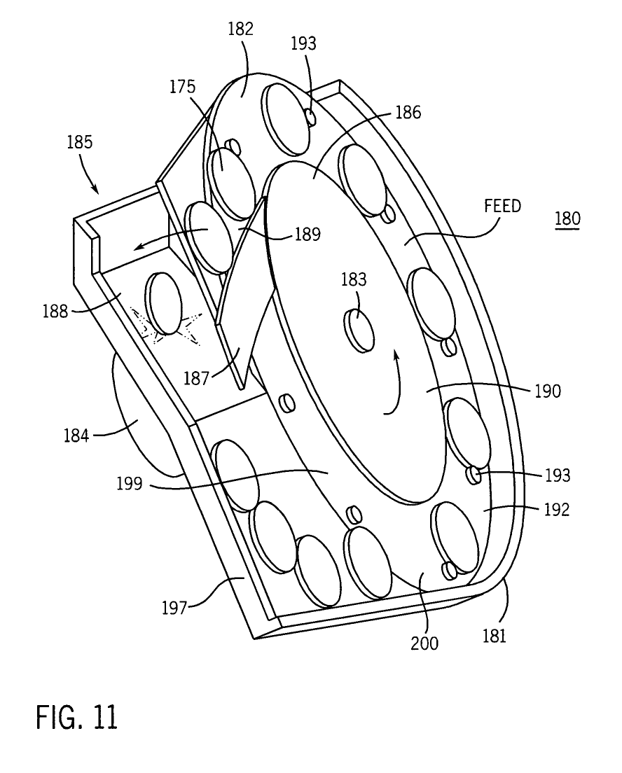

FIG. 10 is a top view of the coin-feeding belt conveyor assembly 160 of FIG. 9. As illustrated in FIGS. 9 and 10, the return plate 170 is configured to generate a coin sound upon receipt of the striking element 175 dropped from the upper extent, or exit end, of the conveyor belt 162 above, and to slideably convey the coin 175 via the force of gravity to a lower position proximate to the drive roller 166. Accordingly, the return plate 170 is preferably constructed of a suitable metallic material having a smooth surface (e.g., steel). This ensures that the sound generated when a coin strikes the return plate 170 is substantially identical to the sound of coins dropping into the coin tray 16, and that the coin can easily slide downward to the lower position proximate to the drive roller 166.

The return plate 170 includes an upper portion 174 and a lower portion 176 bounded by a return plate lip 178. The lower portion 176 terminates in a coin feeding ramp 180 aligned with, or slightly higher than, the top surface of the conveyor belt 162 at a bottom-most location proximate to the drive roller 166. The width of the coin feeding ramp 180 is sized to allow one striking element 175 to pass from the bottom-most location of the return plate 170 and onto an entrance end 163 of the conveyor belt 162 where each striking element 175 is engaged, in sequence, by a horizontal ridge 172.

The upper and lower portions 174, 176, respectively, of the return plate 170 are offset from a vertical plane, with the upper portion 174 at a higher horizontal plane and the lower portion 176 at a lower horizontal plane. The upper portion 174 extends beneath, and at a distance below, the exit end 171. The return plate 170 is sloped downward from its upper portion 174 to align with the lower portion of the conveyor belt 162, terminating in the coin feeding ramp 179. The return plate lip 178 is configured to guide the striking elements 175 as they pass from the upper portion 174 to the lower portion 176 and then through the coin feeding ramp 179 to the entrance end 163 of the conveyor belt 162.

Referring to FIGS. 9 and 10, as the drive roller 166 is rotated in a counter-clockwise direction, striking elements captured by respective ridges 172 of the conveyor belt 162 are elevated from the entrance end 163 towards the exit end 171. After passing over the idler roller 168, each striking element 175, in response to the force of gravity, falls to the return plate below thereby producing the sound of a coin dropping into the coin tray 16. The striking element 175, again urged by the force of gravity and/or guided by the return lip plate 178, slides downward on the return plate 170 to the lower portion 176, and then through the coin feeding ramp 179 and onto the conveyor belt 162 when an open space becomes available. In addition, it is contemplated that the coin-feeding belt conveyor assembly 160 may also include a sensing assembly coupled to the controller 203 as described above, and positioned to count the number of striking elements 175 falling to the upper portion 174.

In another embodiment (not separately illustrated), the respective ridges 172 of the conveyor belt 162 may be adapted to hold more than one striking element. Additionally, it is contemplated that the respective ridges 172 of the conveyor belt 162 may be replaced with bucket-shaped or raised curve-shaped structures adapted to hold two or more striking elements 175.

Another embodiment of the electromechanical coin recirculator, which utilizes a coin-feeding disk conveyor, may also be used as an electromechanical coin sound simulator in the gaming machine 10. For example, FIG. 11 illustrates a top and side perspective view of an electromechanical coin sound simulator in the gaming machine 10 utilizing a coin-feeding disk conveyor assembly 180. The coin-feeding disk conveyor assembly 180 includes disk apparatus 182 and a motor 184. The disk apparatus 182 includes a conveyor disk 186 rotatably coupled to the motor 184 via a motor drive shaft 183, a striking element feeder arm 187, and a sound generating return chute 188.

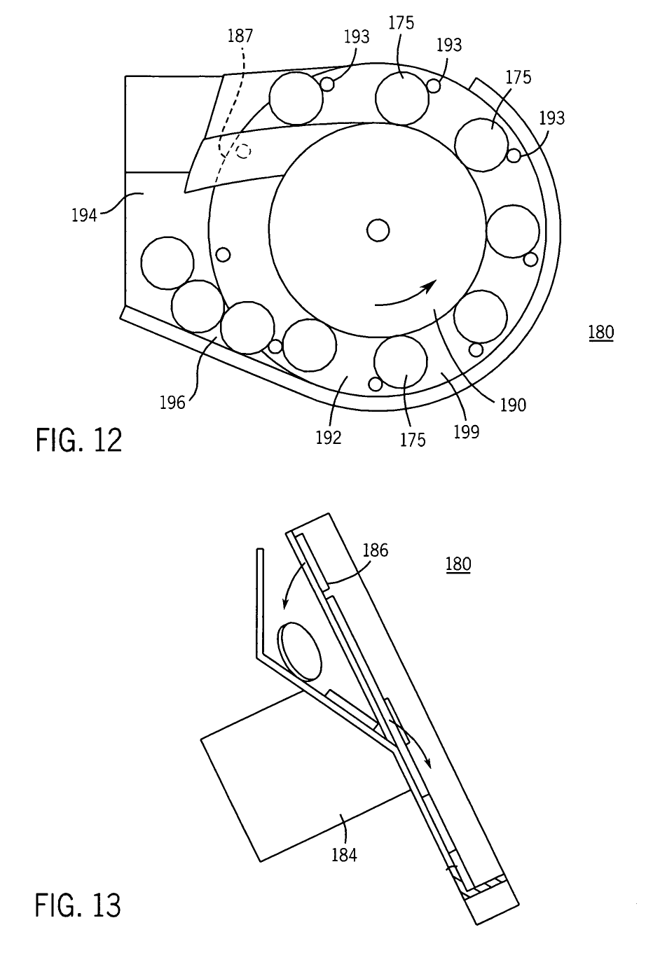

FIG. 12 is a top view of the coin-feeding disk conveyor assembly 180 of FIG. 11. As illustrated in FIGS. 11 and 12, the disk 186 includes an inner portion 190 and an outer portion 192 concentrically disposed about the inner portion 190. The inner portion 190 is preferably slightly elevated a first distance (e.g., a distance equal to the thickness of a coin) above the outer portion 192 in the axial direction. A top surface 199 of the outer portion 192 includes a plurality of perpendicularly mounted striking element retaining pins 193. Each of the striking element retaining pins 193 are preferably located proximate to the outer edge of the top surface 199 and are adapted to hold the striking element 175 (e.g., a coin) against the top surface 199 between its respective striking element retaining pin 193 and the slightly elevated edge of the inner portion 190, through the force of gravity. The spacing between the striking element retaining pins 193 is partially determined by the diameter of the striking element used. In addition, although it can vary, the height of the striking element retaining pins 193 is preferably equal to one-half of the height of the striking element used in the coin-feeding disk conveyor assembly 180. A lip 181, axially disposed around an outer edge portion of the outer portion 192, prevents striking element 175, retained by the coin retaining pins 193, from sliding off of the outer portion 192.

Although not separately illustrated, the coin-feeding disk conveyor assembly 180 is mounted to a rigid frame structure, preferably an “L-shaped” frame or a “U-shaped” frame structure, adapted to be mounted in an interior area formerly occupied by a coin hopper of the gaming machine 10. A blind-mate receptacle disposed on the rigid frame structure electrically couples the coin-feeding disk conveyor assembly 180 to the controller 203.

As illustrated by FIG. 11 (see also, FIG. 13), the coin-feeding disk conveyor assembly 180 is situated in the rigid frame structure such that the disk 186 rotates in counter-clockwise direction in a plane at an angle to a vertical direction, with the plurality of perpendicularly mounted striking element retaining pins 193 extending upward at an angle from a horizontal plane. Although illustrated as having a counter-clockwise rotation, it is contemplated that the disk 186 may also be configured to rotate in a clockwise direction in a plane at an angle to a vertical direction.

The striking element feeder arm 187 is mounted to a support member of the rigid frame structure and is adapted to guide striking element “riding” on the top surface 199, to fall, in response to gravitational forces, upon an upper portion 194 of the return chute 188 below. Thus, the striking element feeder arm 187 is positioned to guide the striking elements 175, succumbing to gravitational forces after they are rotated past their highest horizontal position, to the striking element return chute 188 below.

An underside surface of the striking element feeder arm 187 includes a disposed groove 198 therein. The groove 198 is configured to allow the plurality of striking element retaining pins 193 to pass unimpeded under the striking element feeder arm 187, thereby allowing the disk 186 to rotate freely about its axis. In addition, although slightly elevated above the top surface of the inner portion 190, it is contemplated that the top surface of the coin feeder arm 187 may be coplanar with the top surface of the inner portion 190 of the disk 186.

Referring to FIGS. 11 and 12, the coin return chute 188 is configured generate a coin sound upon receipt of a striking element 175 dropped from an exit end 189 of the disk 186 above, and to convey the striking element 175 downward and onto the sound generating return chute 188. Accordingly, the return chute 188 is preferably constructed of a suitable metallic material having a smooth surface (e.g., steel). This ensures that the sound generated when a striking element 175 strikes the coin return chute 188 is substantially identical to the sound of a coin dropping into the coin tray 16, and that the striking element 175 can easily slide downward under the force of gravity.

The return chute 188 includes an upper portion 194 and a lower portion 196 bounded by a return guide edge 197. The upper and lower portions 194, 196, respectively, are offset from a vertical plane, with the upper portion 194 at a higher horizontal plane and the lower portion 196 at a lower horizontal plane (see, FIG. 13). The upper portion 194 extends beneath and at a distance below a top vertical edge of the striking element feeder arm 198. To mitigate possible striking element obstruction in the lower portion 196, the top surface of the lower portion 196 is configured to be coplanar with, or slightly higher than, the outer portion 190 of the disk 186.

Referring to FIGS. 11, 12 and 13, as the disk 186 is rotated in a counter-clockwise direction by the motor 188, each striking element 175, received from the lower portion 196 via an entrance end 200 of the disk 186, and engaged by one of the perpendicularly mounted striking element retaining pins 193, is rotated upward, past its highest horizontal position. Succumbing to gravitational forces and sequentially released by the striking element feeder arm 187, each striking element 175 falls and impacts upon the metallic, sound generating return chute 188 below, thereby producing the sound of a coin dropping into the coin tray 16.

In addition, it is contemplated that the coin-feeding disk conveyor assembly 180 may also include a sensing assembly coupled to the controller 203 as described above, and positioned to count the number of striking elements 175 falling to the sound generating return chute 188 below.

In yet another embodiment, a recirculation chute may be added to existing gaming machine hoppers (not separately illustrated) to generate a coin sound. The recirculation chute may be configured in one of any number of suitable configurations to re-circulate striking elements 175, tokens, or coins into the existing coin hopper rather than into the coin tray 16. For example, a knife commonly found inside of a typical coin hopper can be re-configured to cause coins drop back into the coin hopper rather than exiting the coin hopper. In this way, like the electromechanical coin sound simulators discussed above, the sound of dropping coins may be simulated in a “cashless” gaming machine.

Although discussed in the context of game play (e.g., winning game outcomes or game sound effects), the coins sounds generated by the electromechanical coin sound simulator discussed above may be used for generating coins sounds when the gaming machine 10 is in an attract mode. For example, attract mode coin sounds could be generated after some predetermined time period of gaming machine inactivity. Alternatively, attract mode coin sounds could be generated after some random time period of gaming machine inactivity.

In another example, the coins sounds generated by any one of the electromechanical coin sound simulators discussed above may be used to amplify an existing coin sound. For example, during an attraction mode, the controller 203 may cause a coin to drop into the coin tray 16 of an idle gaming machine 10 and may cause the sound of many coins dropping to be projected either before, during or after the coin drop, from the idle gaming machine 10. A lucky walk-by patron hearing the “enhanced” coin drop may be rewarded with the dropped coin.

In addition to being coupled to the controller 203 of the gaming machine 10, any of the electromechanical coin sound simulators discussed above may be coupled to, and controlled by another controller in the gaming machine network. For example, a gaming machine network may include one or more gaming machines 10 coupled to a server having a server controller. Each of the gaming machines 10 may include the coin-feeding belt conveyor assembly 160 coupled to the server controller. Constructed and operating much like the controller 203, the server controller can transmit an electromechanical apparatus operation signal to one or more of the coin-feeding belt conveyor assembly(s) 160 to generate coin sounds during, for example group bonus events or cooperative game play. Similarly, the server controller can transmit the electromechanical apparatus operation signal to one or more of the coin-feeding belt conveyor assembly(s) 160 to randomly generate coin sounds associated with winning game outcomes to add audible excitement to a cashless gaming environment. The server controller may also receive an electromechanical results signal from one or more of the coin-feeding belt conveyor assembly(s) 160 where the electromechanical results signal indicates a number of strikes by the striking element.

Referring again to FIG. 1, attached to the door 14 are audio speaker grills 17 and a belly glass area 18 that typically displays game theme artwork. Sounds provided via the audio speaker grills 17 and associated audio speakers may include the sound of spinning slot machine reels, a dealer's voice, music, announcements or any other audio related to the wagering game.

Also attached to the door 14 are a number of value input devices that allow a player to insert non-coin value for game play.

The gaming machine 10 may also include a player tracking area 23 having a card reader 24, a keypad 25 and a small display 26. As will be appreciated by those of ordinary skill in the art, the player tracking area 23 may be located in any number of areas of the gaming machine 10.

The gaming machine 10 also includes a main display device 31 for displaying video game images (e.g., simulated reel symbols, simulated cards, simulated numbers, etc.), or in the case of a mechanical spinning reel slot machine, for displaying a symbol array of artwork and blank symbols affixed to mechanical spinning reels viewable to the player. For video gaming machines, the main display device 31 may be implemented as a CRT, an LCD, a VFD, a plasma display, an organic liquid crystal display or other type of video display suitable for use in a gaming machine, and includes a touch screen. For mechanical spinning reel slot machines, the main display device 31 includes a reel display area and may additionally include a touch screen. Alternatively, the touch screen may be provided at a location disposed part from the main display device 31.

The gaming machine 10 may also include a player control panel 44. The player control panel 44 may be provided with a number of pushbuttons or touch-sensitive areas (i.e., touch screen) that may be pressed by a player to select games, make wagers, make gaming decisions, etc. The player control panel 44 may also include an “intelligent button” 19 with a micro-controller capable of enabling enhanced game play, and with a number of LEDs generating a variety of animation sequences in response to the micro-controller.

Referring again to FIG. 1, when a player inserts value in the gaming machine 10, credits corresponding to the amount deposited are displayed on a credit meter (not separately illustrated) of the gaming machine 10. After depositing the appropriate amount of value and making appropriate selections, the player begins game play by pulling a mechanical arm or by pushing an appropriate button such as a Bet button, a Max Bet button, or a Play button on the player control panel 44. Subsequent game play outcome displayed via the main display device 31 may be determined either centrally or locally (1) using a random number generator (RNG) resulting in a pseudo random set of outcomes, or (2) by selecting a game outcome from a fixed set of outcomes (pooled), or (3) other suitable technique.

Game outcomes displayed on the main display device 31 may include occurrences of non-winning outcomes where no value payout is awarded to the player, or occurrences of winning outcomes (reflected in a pay table) where value payouts are awarded to the player. The value payouts are reflected on the credit meter. Thus, the credit meter decrements by a number with each wager and increments by a number as the result of a win outcome yielding a value payout. Upon game completion, credits remaining on the credit meter are dispensed to the player via a voucher or another suitable coinless method.

FIG. 14 is a block diagram of a number of components that may be incorporated in the gaming machine 10 of FIG. 1. Referring to FIG. 14, the gaming machine 10, includes a controller 203 that may comprise a program memory 202 (including a read only memory (ROM)), a microcontroller-based platform or microprocessor (MP) 204, a random-access memory (RAM) 206 and an input/output (I/O) circuit 208, all of which may be interconnected via a communications link, or an address/data bus 210.

FIG. 14 illustrates that multiple peripheral devices, depicted as peripheral devices 211, 212, and 214, may be operatively coupled to the I/O circuit 208. The peripheral devices may include a control panel with buttons, a note acceptor, a bill validator, a card reader, a keypad, a sound circuit driving speakers, a card reader display, a touch screen, an electromechanical coin sound simulator, to name a few. In the case of a spinning reel slot machine, the peripheral devices may further include a number of electromechanical spinning reels and a mechanical arm similarly coupled to the I/O circuit 208. Although three peripheral devices are depicted, more or less peripheral devices may be included.

It should be appreciated that although the controller 203 is a preferable implementation of the present invention, the present invention also includes implementation via one or more application specific integrated circuits (ASICs), field programmable gate arrays (FPGA), adaptable computing integrated circuits, one or more hardwired devices, or one or more mechanical devices.

As may be apparent from the discussion above, the gaming machine with an electromechanical coin sound simulator provides variations of realistic coin sounds and vibrations experienced by a player during game play. As a result, the “silence” experienced by a player in a cashless, coinless gaming environment, is replaced with the exciting coin sounds associated with winning game outcomes, cashing-out and other game events. However, the undesirable elements associated with traditional coin usage in a gaming machine, are eliminated.

From the foregoing, it will be observed that numerous variations and modifications may be affected without departing from the scope of the novel concept of the invention. It is to be understood that no limitations with respect to the specific methods and apparatus illustrated herein is intended or should be inferred. It is, of course, intended to cover by the appended claims all such modifications as fall within the scope of the claims.

1. An electromechanical apparatus for coin sound simulation in a gaming machine having a gaming machine controller including a processor and a memory coupled to the processor, the apparatus comprising:
a motor assembly coupled to the gaming machine controller; and
an arm assembly activated for rotative movement by the motor assembly, the arm assembly including portions adapted to strike a first gaming machine portion to generate coin sound.

2. The apparatus of claim 1, wherein the coin sound is substantially identical to a sound generated by a plurality of game coins dropping into a coin tray of the gaming machine.

3. The apparatus of claim 1, wherein the first gaming machine portion is an interior metallic portion of the gaming machine.

4. The apparatus of claim 1, wherein the first gaming machine portion is an exterior metallic portion of the gaming machine.

5. The apparatus of claim 1, further comprising a server controller operatively coupled to the gaming machine controller, the server controller adapted to transmit an electromechanical apparatus operation signal to the gaming machine controller and to receive an electromechanical apparatus results signal from the gaming machine controller.

6. The apparatus of claim 1, wherein the arm assembly is coupled to the motor assembly via a motor drive shaft, and wherein the arm assembly rotates responsive to the motor assembly and causes the arm assembly portions to sequentially strike the first gaming machine portion.

7. The apparatus of claim 6, wherein the arm assembly comprises:
a plurality of radially extending arms, the outermost ends of each of the plurality of radially extending arms having an aperture therethrough;
a plurality of pivot pins, one of each of the plurality of pivot pins disposed in a respective aperture; and
the arm assembly portions including a plurality of striking elements, one of each of the plurality of striking elements eccentrically mounted to a respective pivot pin for free rotation about the respective pivot pin.

8. The apparatus of claim 7, wherein each of the plurality of striking elements comprise a game token.

9. The apparatus of claim 7, wherein the first gaming machine portion of the gaming machine comprises a metallic striker panel mounted to a second gaming machine portion of the gaming machine.

10. The apparatus of claim 7, further comprising a striking element sensing assembly coupled to the motor assembly and the gaming machine controller, the striking element sensing assembly adapted to detect a number of the plurality of striking elements striking the first gaming machine portion.

11. The apparatus of claim 10, wherein the striking element sensing assembly further comprises:
a multilink arm paddle coupled to the motor assembly via the motor drive shaft, the multilink arm paddle mounted at a location separate from the location of the multilink arm assembly, the multilink arm paddle having a plurality of radially extending paddles, the plurality of radially extending paddles equal in number to the plurality of the radially extending arms and in fixed alignment with the plurality of radially extending arms, the multilink arm paddle rotating responsive to the motor assembly; and
a sensor proximate to the multilink arm paddle, the sensor configured to detect a number of the plurality of radially extending paddles when the multilink arm paddle is rotating, the number of the radially extending paddles equivalent to the number of striking elements striking the first gaming machine portion.

12. The apparatus of claim 1, wherein the motor assembly comprises:
a motor communicatively coupled to the gaming machine controller; and
a cam coupled to the motor via a drive shaft, the cam rotatably driven by the motor and including a plurality of elongated extensions with dwell portions therebetween.

13. The apparatus of claim 12, wherein the arm assembly comprises:
a bracket mounted to the first gaming machine portion, the bracket including a first flange having a first aperture formed therein and a second flange having a second aperture formed therein;
a spring biased arm including a cam follower portion in association with the cam and an extension portion in association with the first gaming machine portion, the spring biased arm having a third aperture formed therein between the cam follower portion and the extension portion;
a pivot pin disposed in the first aperture and the second aperture and the third aperture, the pivot pin adapted to pivotally mount the spring biased arm between the first flange and the second flange; and
a resilient member disposed about the pivot pin between the spring biased arm and the first flange, the resilient member configured to bias the extension portion of the spring biased arm in a clockwise direction towards impact with the first gaming machine portion.

14. An electromechanical apparatus for sound simulation in a gaming machine, the gaming machine including a gaming machine controller including a processor and a memory coupled to the processor, the electromechanical apparatus comprising:
a solenoid housing coupled to the gaming machine controller and an electrical signal source, the solenoid housing having a core passageway extending coaxially between a closed end of the solenoid housing and an open end of the solenoid housing;
a spring loaded solenoid core disposed in the core passageway and adapted to axially reciprocally move in response to an electrical signal from the electrical signal source, the spring loaded solenoid core including an extended portion extending from the open end of the solenoid housing; and
a core striker mounted to an exposed end of the extended portion and configured to generate an audible sound when striking a gaming machine surface of the gaming machine, the core striker having a radially disposed collar.

15. The electromechanical apparatus of claim 14, further comprising a spring extending around the extended portion of the spring loaded solenoid core between the collar of the core striker and the open end of the solenoid housing.

16. The electromechanical apparatus of claim 15, wherein the spring biases the spring loaded solenoid core into contact with the gaming machine surface.

17. The electromechanical apparatus of claim 16, wherein the spring loaded solenoid core is retracted into the solenoid housing in response to application of the electrical signal, and wherein the core striker strikes the gaming machine surface and generates an audible sound in response to removal of the electrical signal.

18. The electromechanical apparatus of claim 14, wherein the audible sound comprises an audible sound substantially identical to a sound generated by a plurality of game coins dropping into a coin tray of the gaming machine.

19. The electromechanical apparatus of claim 14, further comprising a server controller operatively coupled to the gaming machine controller, the server controller adapted to transmit an electromechanical apparatus operation signal to the gaming machine controller and to receive an electromechanical apparatus results signal from the gaming machine controller.

20. A method for generating a coin sound in a gaming machine having a gaming machine controller and an electromechanical member coupled to the gaming machine controller, the gaming machine controller including a processor and a memory coupled to the processor, the method comprising:
detecting a signal; and
in response to the signal, causing a metallic portion of the electromechanical member to strike a metallic portion of the gaming machine to generate the coin sound, the coin sound substantially identical to a sound generated by at least one coin dropping into a coin tray of the gaming machine.

21. The method of claim 20, further comprising:
prior to causing the metallic portion of the electromechanical member to strike the metallic portion of the gaming machine, determining a number of strikes based on the signal;
activating the electromechanical member for a time period corresponding to the determined number of strikes; and deactivating the electromechanical member at the end of the time period.

22. The method of claim 20, wherein detecting the signal comprises receiving a winning game outcome indication having an associated award amount, and wherein the number of strikes corresponds to the associated award amount.

23. The method of claim 20, wherein detecting the signal comprises receiving a cash-out indication having an associated cash-out amount, and wherein the number of strikes corresponds to the cash-out amount.

24. The method of claim 20, wherein detecting the signal comprises receiving a game event indication having an associated audio event, and wherein the number of strikes corresponds to the audio event.

25. The method of claim 20, wherein detecting the signal comprises receiving an indication from a server coupled to the gaming machine, the indication initiating electromechanical member operation.
